(19) United States
(12) Patent Application Publication
(10) Pub. No.: US 2007/0075098 A1
(43) Pub. Date: Apr. 5, 2007

(54) Paint supply device

(76) Inventor: Miguel Wang, Chang-Hua Hsien (TW)

Correspondence Address: CHRISTIE, PARKER & HALE, LLP, PO BOX 7068, PASADENA, CA, 91109-7068, US

(21) Appl. No.: 11/362,294

(22) Filed: Feb. 23, 2006

(30) Foreign Application Priority Data
Sep. 13, 2005 (TW) 094131519

(51) Int. Cl. G01F 11/00; B65D 88/54

(52) U.S. Cl. 222/324; 222/321.9

(57) ABSTRACT

A paint supply device includes a container defining a paint-storing chamber therein, a piston-and-cylinder assembly, and a finger-holding unit connected to the container. The container has a top threaded portion, and a cap secured to the top threaded portion. The piston-and-cylinder assembly includes a cylinder extending into the paint-storing chamber, and a hollow piston rod extending into the cylinder for withdrawing paint from the container to a paint applicator and having a top end disposed above the cap. A connecting head is connected to the top end of the piston rod, and is adapted to be connected to the paint applicator. The finger-holding unit has a hook member defining at least one finger-receiving recess disposed between the connecting head and the cap.

### CROSS-REFERENCE TO RELATED APPLICATION

This application claims priority of Taiwanese Application No. 094131519, filed on Sep. 13, 2005.

### BACKGROUND OF THE INVENTION

1. Field of the Invention

The invention relates to a paint supply device, more particularly to a paint supply device with a finger-holding unit.

2. Description of the Related Art

A conventional paint supply device includes a container, and a press unit installed on the container. The container is attached with a back strap to facilitate carrying of the container by a user. When the user operates the press unit, paint is withdrawn from the container, and passes through a connecting tube and into a paint applicator.

The aforementioned conventional paint supply device is inconvenient to operate since it is not possible to both hold and operate the press unit with one hand. Further, the conventional paint supply device has inability to control paint supply amounts.

### SUMMARY OF THE INVENTION

Therefore, the object of the present invention is to provide a paint supply device that is capable of overcoming the aforementioned drawback of the prior art.

According to this invention, a paint supply device comprises a container, a piston-and-cylinder assembly, a connecting head, and a finger-holding unit. The container defines a paint-storing chamber therein, and has a top threaded portion, and a cap secured to the top threaded portion. The piston-and-cylinder assembly includes a cylinder extending into the paint-storing chamber, and a hollow piston rod extending into the cylinder for withdrawing paint from the container to a paint applicator. The hollow piston rod has a top end disposed above the cap. The connecting head is connected to the top end of the piston rod, and is adapted to be connected to the paint applicator. The finger-holding unit is connected to the container, and has a hook member defining at least one finger-receiving recess disposed between the connecting head and the cap.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of the first preferred embodiment of a paint supply device according to the present invention in a state of use;

FIG. 2 is a partly fragmentary exploded sectional view of the first preferred embodiment;

FIG. 3 is an assembled sectional view of the first preferred embodiment;

FIG. 4 is a view similar to FIG. 3, but illustrating how the first preferred embodiment is operated;

FIG. 5 is a perspective view of the second preferred embodiment of a paint supply device according to the present invention; and

FIG. 6 is a sectional view of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

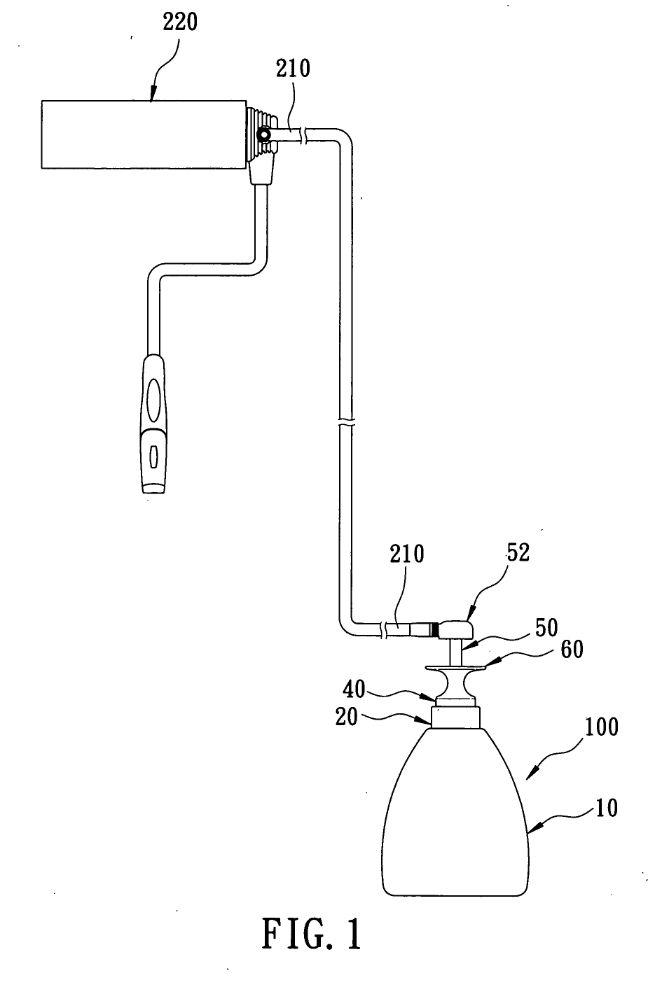

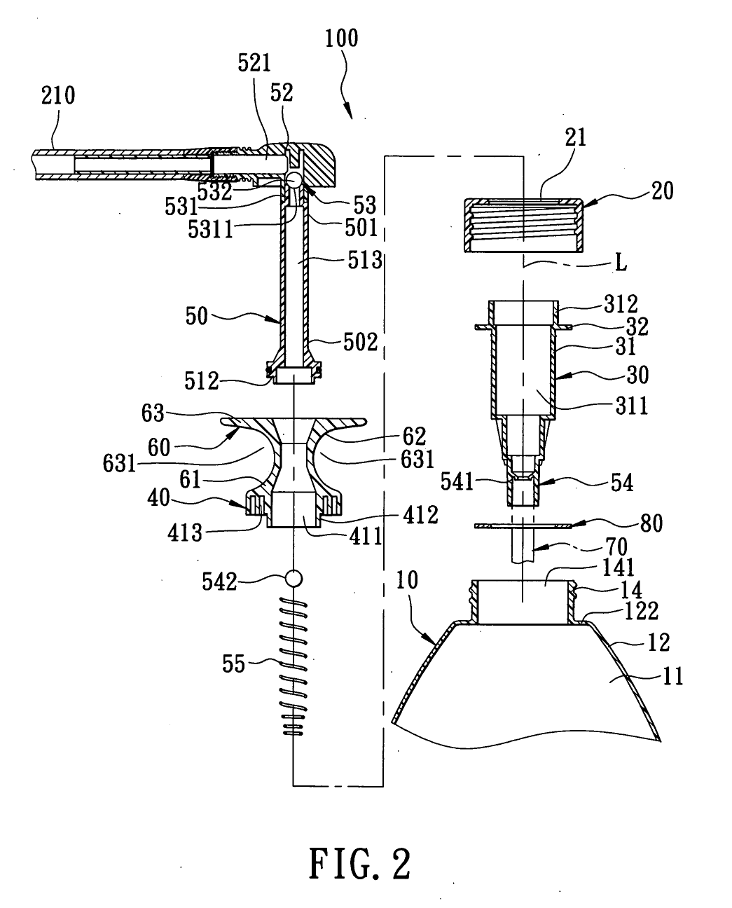

Referring to FIGS. 1 to 4, the first preferred embodiment of a paint supply device 100 according to the present invention is adapted to be connected to a paint applicator 220 through a connecting tube 210, and is shown to comprise a container 10, a piston-and-cylinder assembly, a piston-limiting member 40, a connecting head 52, a finger-holding unit 60, and a suction tube 70.

The container 10 includes a surrounding wall 12, an annular shoulder 122 connected to a top periphery of the surrounding wall 12, a top threaded portion 14 extending upwardly and axially from the annular shoulder 122 and having a top opening 141, a bottom wall 13 connected to a bottom periphery of the surrounding wall 12 and cooperating with the surrounding wall 12 to define a paint-storing chamber 11, and a cap 20 engaged threadedly to the top threaded portion 14 and having a through hole 21 aligned with the top opening 141. A washer 80 is disposed between the cap 20 and the top threaded portion 14.

The piston-and-cylinder assembly includes a cylinder 30, a hollow piston rod 50, and a spring member 55. The cylinder 30 defines an axis (L), and has an inner peripheral wall formed with a stepped portion and defining an axial cavity 311 that is in fluid communication with the paint-storing chamber 11 in the container 10. The cylinder 30 further has a top end portion 312, a bottom end portion 31, a flanged portion 32, and a lower one-way valve 54. The top end portion 312 extends through the through hole 21 in the cap 20 so as to be disposed outwardly of the top threaded portion 14 of the container 10. The bottom end portion 31 extends into the paint-storing chamber 11 in the container 10. The flanged portion 32 projects outwardly, radially, and integrally from an outer peripheral wall of the cylinder 30 between the top and bottom end portions 312, 31, and is pressed between the cap 20 and the top threaded portion 14 of the container 10. The lower one-way valve 54 is disposed within the axial cavity 311, and includes a valve seat 541 connected integrally to the bottom end portion 31 of the cylinder 30 and defining a valve opening 5411, and a ball body 542 seated removably on the valve seat 541 for closing and opening of the valve opening 5411. The lower one-way valve 54 selectively permits flowing of paint from the paint-storing chamber 11 into the axial cavity 311 in the cylinder 30, but not in the opposite direction.

The hollow piston rod 50 extends into the cylinder 30, and has a piston head 512 connected to a bottom end 502 of the piston rod 50 and disposed slidably within the axial cavity 311 in the cylinder 30, and a guide hole 513 formed through the piston rod 50 and the piston head 512. The piston rod 50 has a top end 501 disposed above the cap 20 and provided with an upper one-way valve 53. The upper one-way valve 53 is disposed within the guide hole 513, and includes a valve seat 531 connected integrally to the piston rod 50 and defining a valve opening 5311, and a ball body 532 seated removably on the valve seat 531 for closing and opening of the valve opening 5311. The upper one-way valve 53 selectively permits flowing of paint from the axial cavity 311 in the cylinder 30 to the connecting tube 210, but not in the opposite direction.

The spring member 55 is disposed between the piston rod 50 and the lower one-way valve 54 for biasing the piston rod 50 away from the lower one-way valve 54.

The piston-limiting member 40 is disposed on the cap 20, and has an inner hole 411 for extension of the piston rod 50 therethrough, an annular protrusion 412 extending downwardly from a wall defining the inner hole 411 and into the top threaded portion 14 of the container 10, and an annular retaining groove 413 formed around the protrusion 412. The top end portion 312 of the cylinder 30 is fitted into the retaining groove 413 so that the piston-limiting member 40 is engaged to the top end portion 312 of the cylinder 30.

The connecting head 52 is connected fixedly to the top end 501 of the piston rod 50, and includes an outlet 521 adapted to be connected to the connecting tube 210, which in turn, is connected to the paint applicator 220 as described above.

In this embodiment, the finger-holding unit 60 is configured as a hollow body. During assembly, the piston rod 50 is passed through the finger-holding unit 60, the inner hole 411 in the piston-limiting member 40, the through hole 21 in the cap 20, and into the axial cavity 311 in the cylinder 30, so that the finger-holding unit 60 is disposed around the piston rod 50. The finger-holding unit 60 includes a lower bell-shaped portion 61 that is integrally formed with the piston-limiting member 40, and an upper bell-shaped portion 62 that extends upwardly from the lower bell-shaped portion 61 and that cooperates with the lower bell-shaped portion 61 to define a hook member 63. The hook member 63 defines at least one finger-receiving recess 631 that is disposed between the connecting head 52 and the cap 20.

The suction tube 70 has one end inserted into the bottom end portion 31 of the cylinder 30 adjacent to the lower one-way valve 54, and another end extending into the paint-storing chamber 11 in the container 10.

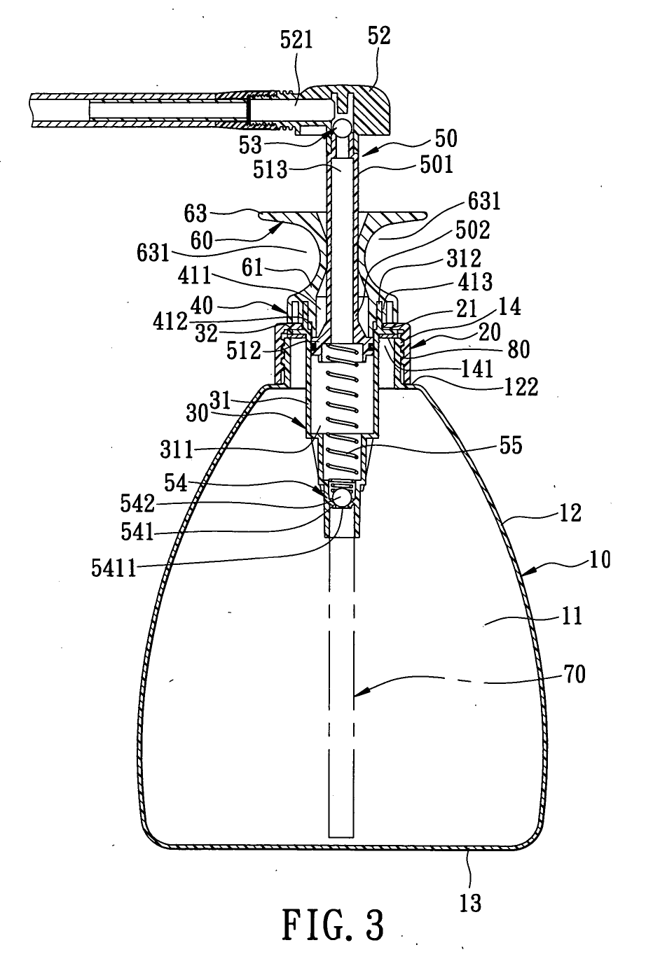

After assembly, the piston rod 50 is disposed at an upper position, as best shown in FIG. 3, where the piston head 512 is disposed proximate to the top end portion 312 of the cylinder 30, and abuts against the protrusion 412 of the piston-limiting member 40 due to the biasing action of the spring member 55. The connecting head 52, at this time, is spaced apart from the hook member 63 of the finger-holding unit 60.

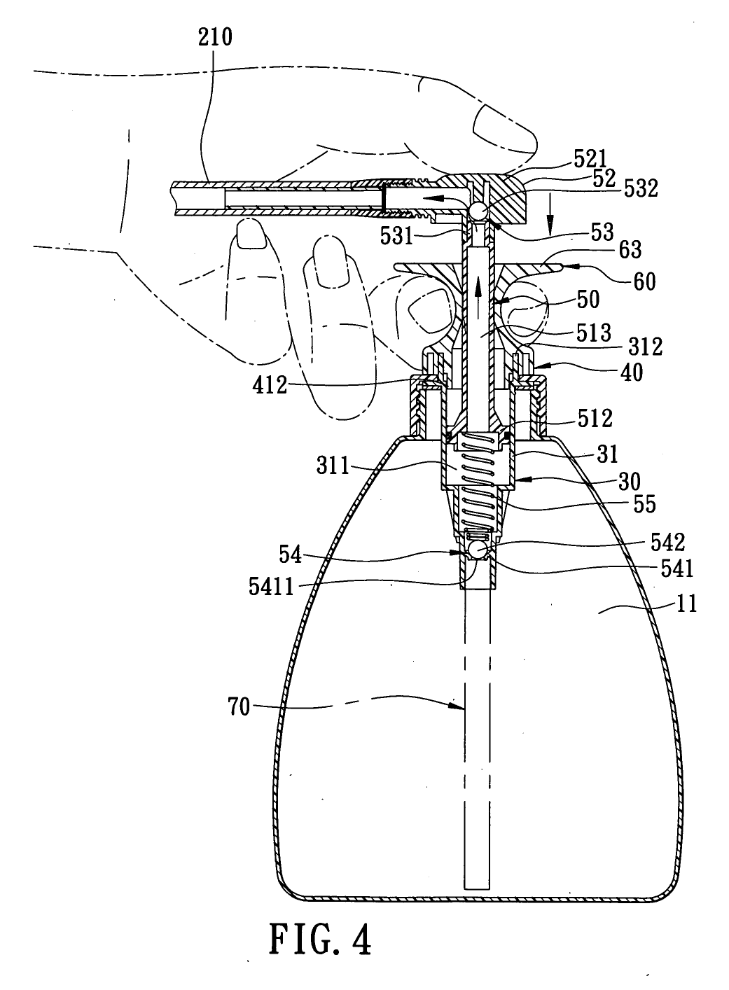

During use, as best shown in FIG. 4, in a state where the forefinger and middle finger of the user are respectively positioned in the finger-receiving recess 631 of the finger-holding unit 60, the thumb of the user presses the connecting head 52 toward the hook member 63 of the finger-holding unit 60 so as to move the piston rod 50 to a lower position, where the piston head 512 is moved downwardly and away from the protrusion 412 of the piston-limiting member 40 to thereby press against the ball body 542 of the lower one-way valve 54. As a result, the ball body 542 blocks the valve opening 5411 in the lower one-way valve 54, thereby preventing fluid communication between the axial cavity 311 and the paint-storing chamber 11. The spring member 55 is compressed at this time. As the piston head 512 moves toward the bottom end portion 31 of the cylinder 30, the volume in the axial cavity 311 is reduced, such that paint that is stored in the axial cavity 311 is forced into and passes through the guide hole 513 in the piston rod 50, the valve opening 5311 in the upper one-way valve 53, and the outlet 521 in the connecting head 52, and into the connecting tube 210, as shown by the arrows in FIG. 4. During this operation, the paint that was previously stored in the axial cavity 311 pushes the ball body 532 of the upper one-way valve 53 upwardly so as to move the ball body 532 away from the valve seat 531, thereby allowing the paint to flow from the guide hole 513 to the outlet 521 in the connecting head 52 via the valve opening 5311 in the valve seat 531.

When the downward pressing force of the connecting head 52 is released, through a restoring force of the spring member 55, the piston rod 50 and the connecting head 52 are restored to their respective original positions, as shown in FIG. 3. During this return process, the volume of the axial cavity 311 is increased, and the paint in the paint-storing chamber 11 is automatically sucked from the paint-storing chamber 11 into the axial cavity 311 through the suction tube 70, thereby readying the paint supply device 100 for the next supply operation.

From the aforementioned description, it is apparent that by positioning the user's fingers in the finger-receiving recess 631 of the finger-holding unit 60 and on the connecting head 52, the user can both operate and hold the paint supply device 100 of the present invention with one hand, as well as accurately control the force used to supply paint so that the amount of paint withdrawn from the paint-receiving chamber 11 in the container 10 can be matched to the speed of operation of the paint applicator 220.

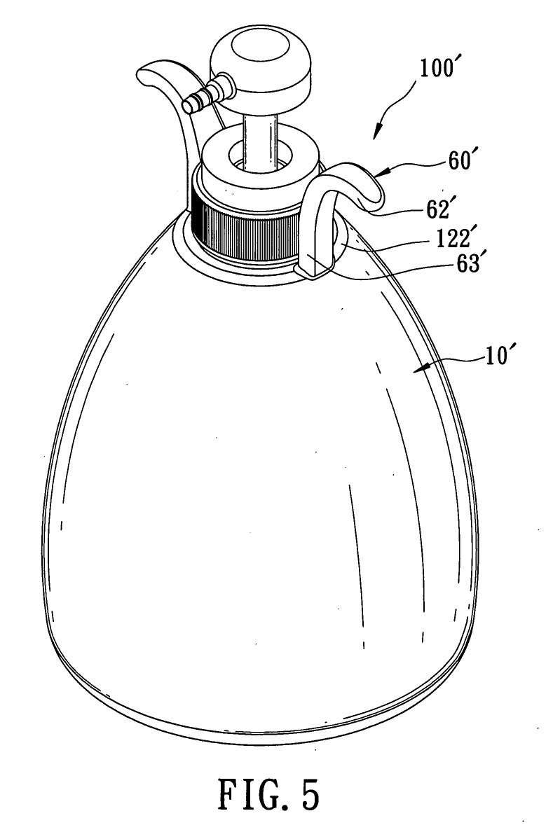

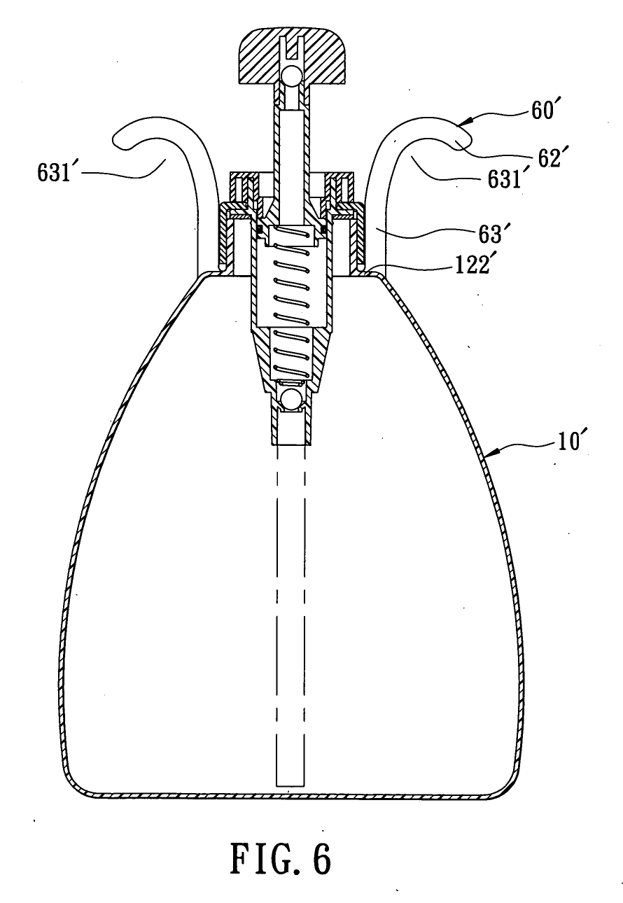

Referring to FIGS. 5 and 6, the second preferred embodiment of a paint supply device 100′ according to the present invention is shown to be similar to the first preferred embodiment. However, in this embodiment, the finger-holding unit 60′ includes a pair of curved horns 62′ that cooperatively define the hook member 63′. The curved horns 62′ extend upwardly from the annular shoulder 122′ of the container 10′, and define respectively finger-receiving recesses 631′.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A paint supply device comprising:
a container defining a paint-storing chamber therein and having a top threaded portion and a cap secured to said top threaded portion;
a piston-and-cylinder assembly including a cylinder extending into said paint-storing chamber, and a hollow piston rod extending into said cylinder for withdrawing paint from said container to a paint applicator, said hollow piston rod having a top end disposed above said cap;
a connecting head connected to said top end of said piston rod and adapted to be connected to the paint applicator; and
a finger-holding unit connected to said container and having a hook member that defines at least one finger-receiving recess disposed between said connecting head and said cap.

2. The paint supply device of claim 1, wherein said cylinder has a top end portion extending outwardly of said top threaded portion, said paint supply device further comprising a piston-limiting member disposed on said cap, engaging said top end portion of said cylinder, and having a protrusion extending into said top threaded portion, said protrusion abutting against said piston rod when said piston rod is disposed at an upper position, and being spaced apart from said piston rod when said piston rod is disposed at a lower position.

3. The paint supply device of claim 2, wherein said piston-limiting member is formed with a retaining groove around said protrusion, said top end portion of said cylinder being fitted into said retaining groove in said piston-limiting member.

4. The paint supply device of claim 1, wherein said finger-holding unit is disposed around said piston rod, and includes a lower bell-shaped portion that is integrally formed with said piston-limiting member, and an upper bell-shaped portion that extends upwardly from said lower bell-shaped portion and that cooperates with said lower bell-shaped portion to define said hook member.

5. The paint supply device of claim 1, wherein said container is formed with an annular shoulder, said top threaded portion extending upwardly and axially from said annular shoulder, said hook member including a pair of curved horns that extend upwardly from said annular shoulder.
